(19) United States
(12) Patent Application Publication
(10) Pub. No.: US 2025/0252674 A1
(43) Pub. Date: Aug. 7, 2025

(54) Plane Estimation via 3D-Consistent Embeddings

(71) Applicant: Niantic, Inc., San Francisco, CA (US)

(72) Inventors: James Watson, London (GB); Filippo Aleotti, London (GB); Mohamed Amr Abdelfattah Sayed, London (GB); Zawar Imam Qureshi, London (GB); Oisin Mac Aodha, Edinburgh (GB); Gabriel J. Brostow, London (GB); Michael David Firman, London (GB); Sara Alexandra Gomes Vicente, London (GB)

(21) Appl. No.: 19/044,430

(22) Filed: Feb. 3, 2025

Related U.S. Application Data
(60) Provisional application No. 63/549,154, filed on Feb. 2, 2024.

(51) Int. Cl. G06T 17/20; G06T 7/70; G06V 10/762; G06V 20/70

(52) U.S. Cl. CPC G06T 17/20; G06T 7/70; G06V 10/762; G06V 20/70; G06T 2207/30244

(57) ABSTRACT

Depth maps are generated based on a sequence of posed images captured by a camera, the depth maps are fused into a truncated signed distance function (TSDF), and an initial estimate of 3-dimensional (3D) scene geometry is generated by extracting a 3D mesh via the TSDF. 3D embeddings are estimated for each vertex in the 3D mesh by mapping each vertex to a multi-view consistent plane embedding space such that vertices on a same plane map to nearly a same place in the embedding space. The vertices are clustered into 3D plane instances based on respective 3D embeddings and geometry information defined by the 3D mesh to create a planar representation of the scene. A location of a virtual element in a virtual world of an augmented reality game is determined based on the planar representation.

### BACKGROUND

### 1. Technical Field

The subject matter described relates generally to plane estimation, and, in particular, to estimating planar surfaces from a 3D scene based on posed images.

### 2. Problem

3D plane estimation using planar scene reconstruction has applications in robotics, path planning, and augmented reality (AR). Multiple solutions have been proposed to estimate 3D planes from single images. Top-down approaches directly predict a mask and the parameters of each plane in the image (or for a fixed number of planes). In contrast, bottom-up approaches first map pixels into embeddings, which can subsequently be grouped into planes via a clustering algorithm. More recent works leverage the query learning mechanism of Vision Transformers to achieve state-of-the-art single-image results. These methods process frames independently, and there is limited work that extends these learning-based single image methods to a multi-image setting.

### SUMMARY

This disclosure pertains to a method for determining consistent plane embeddings from a sequence of posed RGB images or frames, and grouping the embeddings into plane instances that match the same plane across different frames to uncover distinct and accurate planar regions in a 3D scene. Techniques disclosed may leverage a per-scene function (e.g., multilayer perceptron (MLP)) which maps points on the same plane to nearby positions in embedding space. The embeddings may be clustered using geometrical priors to generate accurate planar reconstructions. The planar reconstruction method generates an initial estimate of 3D scene geometry by estimating depth maps based on a sequence of posed images captured by a camera, fusing the depth maps into a truncated signed distance function (TSDF), and extracting a 3D mesh via the TSDF. For vertices in the 3D mesh, the method estimates a 3D embedding vector by mapping the vertex to a multi-view consistent plane embedding space such that vertices on the same plane map to nearly the same place in the embedding space. The method then clusters the vertices into 3D plane instances based on respective 3D embeddings and geometry information defined by the 3D mesh to create a planar representation of a 3D scene. The planar representation can be utilized for determining and tracking a location of a virtual object in a virtual world, such as the world of an AR game.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for estimating planar surfaces from a 3D scene based on posed images, according to one embodiment.

FIG. 4 depicts a block diagram of a process for determining planar representations of a scene, in accordance with at least one embodiment.

FIG. 5 is a flowchart describing an example method for causing placement of a virtual object at a determined planar representation of a scene, according to one or more embodiments.

FIG. 6 is a flowchart describing an example method for training a machine learning model to determine multi-view consistent embeddings of a scene, according to one or more embodiments.

FIG. 7 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where planar scene reconstruction is desirable. In addition, the inherent flexibility of computer-based systems allows for a great variety of possible configurations, combinations, and divisions of tasks and functionality between and among the components of the system.

### Example Location-Based Parallel Reality Game

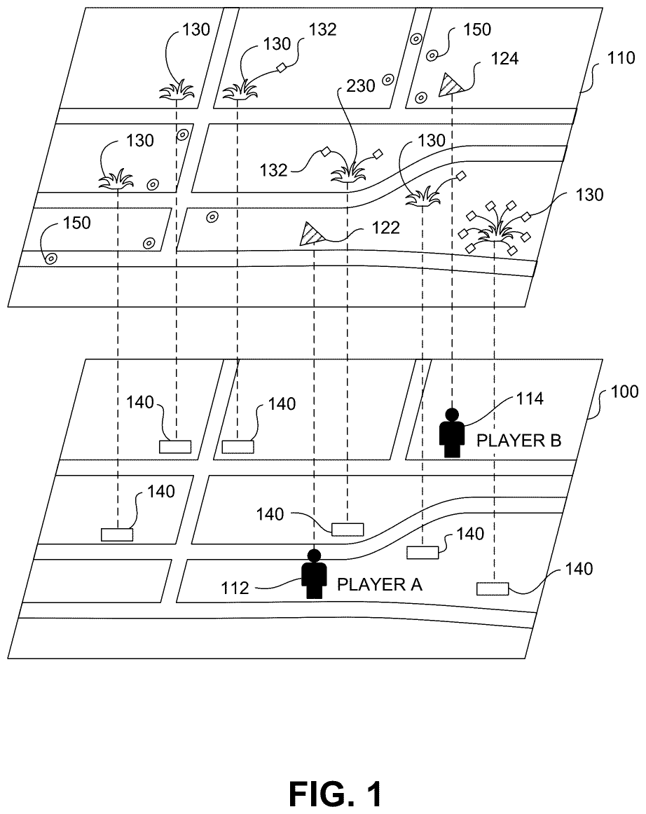

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

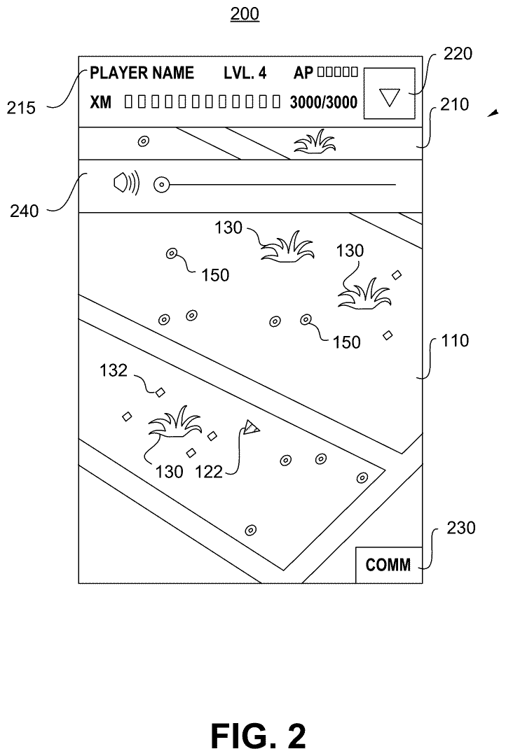

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

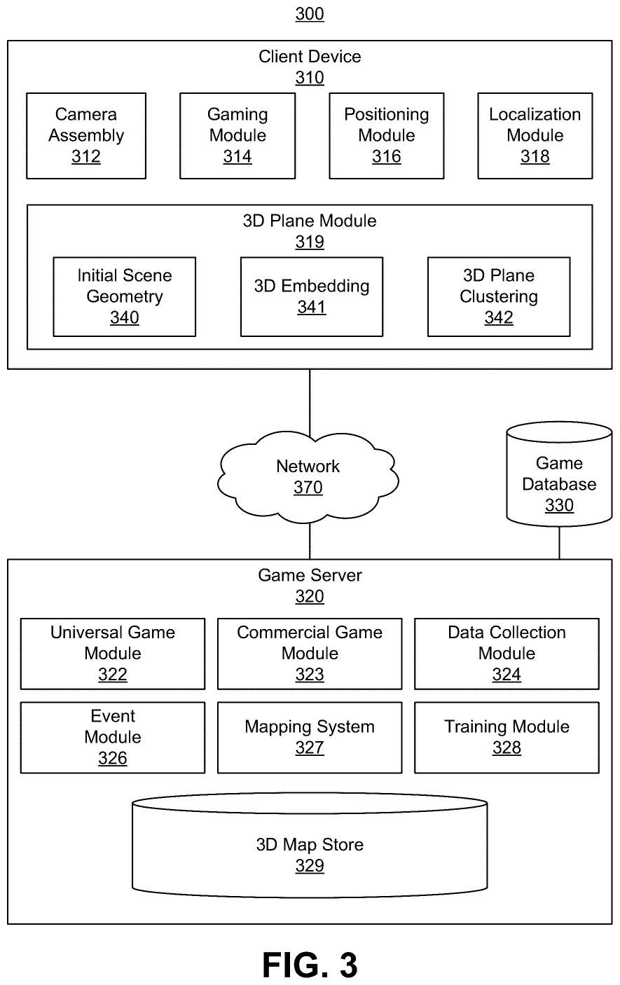

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, a localization module 318, and a 3D plane module. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

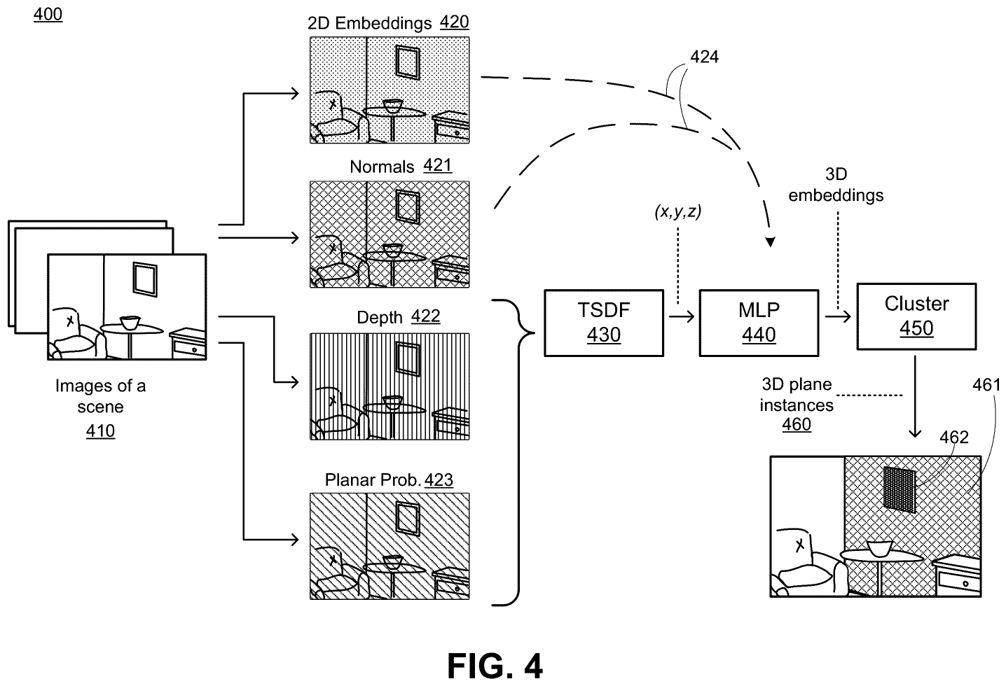

The 3D plane module 319 may take as input images captured by the camera assembly 312 and the pose of each of the images determined by the localization module 318. Using the input, the 3D plane module 319 may create a planar scene representation in which the same planes are matched and represented as being the same across different frames, enabling tracking of virtual objects at virtual locations that are mapped to real-world locations across plural frames during an AR session. The 3D plane module 319 may include an initial scene geometry submodule 340, a 3D embedding submodule 341, and a 3D plane clustering submodule 342. An example process for creating a planar scene representation by the 3D estimation module 319 is further described with respect to FIG. 4.

The initial scene geometry submodule 340 may determine pixel depths, planar probabilities, and 2D planar embeddings (e.g., per-pixel embeddings) for an image frame (e.g., captured by the camera assembly 312). The initial scene geometry submodule 340 may estimate depth using one or more of a multi-view stereo neural network, 3D convolutions, or any suitable method for reconstructing a 3D volumetric feature space. The initial scene geometry submodule 340 may extract a 3D mesh by fusing the pixel depths and planar probabilities into a truncated signed distance function (TSDF). In one example of determining a 3D mesh, the initial scene geometry submodule 340 may use SimpleRecon, a 3D reconstruction system from posed images. SimpleRecon leverages a two-dimensional (2D) convolutional neural network described further in U.S. patent application Ser. No. 18/144,099, which is incorporated by reference.

The initial scene geometry submodule 340 may determine a probability that a given pixel of an image belongs to a planar or non-planar region, which is referred to as a planar probability. Non-planar regions include curved surfaces (e.g., a person's body) or a surface that is too small to be treated as a plane (e.g., the surface of a flat button). The initial scene geometry submodule 340 may use a 2D convolutional neural network to determine the planar probability. In one example, the 2D convolutional neural network of SimpleRecon may be adapted to perform both 3D reconstruction and determine a planar probability. The initial scene geometry submodule 340 may use an additional channel in the TSDF for pixel planar probabilities. That is, the initial scene geometry submodule 340 may store within each mesh vertex, or voxel, of a 3D grid the planar probability for a given pixel of an image of the scene in addition to a representation of a depth at the given pixel.

The initial scene geometry submodule 340 may exclude voxels whose aggregated non-planar probability does not meet a threshold non-planar probability (i.e., the probability that the pixel belongs to a planar region is less than a threshold probability). For example, the initial scene geometry submodule 340 may exclude vertices of the 3D mesh that have an aggregated non-planar probability of less than 0.25. In this way, when determining a 3D mesh, the initial scene geometry submodule 340 excludes non-planar regions in the final 3D mesh. The initial scene geometry submodule 340 may determine a 2D embedding of a pixel using a machine learning model (e.g., a convolutional neural network). The initial scene geometry submodule 340 may determine an image-space normal of a pixel in an image using pixel values (e.g., R, G, and B components of the pixel).

The 3D embedding submodule 341 may determine 3D embeddings for vertices of the 3D mesh determined by the initial scene geometry submodule 340. A 3D embedding may be an embedding in a 3D world as opposed to an embedding in the image space. Each 3D point may be associated with a feature vector, the 3D embedding. Although “3D” is used, these embeddings may exist in any N-dimensional space (e.g., rather than an embedding space with three dimensions, using a 1D, 2D, 4D, 25D, etc. dimensional space). Each 3D embedding may be a multi-view consistent embedding. That is, for a given scene, a 3D embedding determined from a pixel depicting a spot in a first image may be the same as a 3D embedding determined from a pixel depicting the same spot in a second image. Thus, a spot or area of a plane in a given scene can be represented in 3D by one multi-view consistent embedding across various images of the scene (e.g., images taken at different camera poses).

The 3D embedding submodule 341 may use a per-scene mapping function to determine one or more 3D embeddings. One example of a per-scene mapping function is a multilayer perceptron (MLP), which receives as input a 3D point and outputs a predicted 3D embedding. The MLP may be represented as function ϕ, which inputs 3D point p to predict the 3D embedding for p, eₚ=ϕ(p). In one example, the MLP ϕ may be a three-layer MLP with 128 dimensions for each hidden layer.

The 3D embedding submodule 341 may train a machine learning model (e.g., the MLP ϕ) to predict 3D embeddings using 2D embeddings as supervisory signals. For a pair of pixels i and j in a single image, the 3D embedding submodule 341 may use corresponding 2D embeddings, xᵢ and xⱼ, as supervisory signals. The 3D embedding submodule 341 may obtain the pixel depths, pᵢ and pⱼ, and the image-space normals, nᵢ and nⱼ, of the pair of pixels as output from the initial scene geometry submodule 340. The 3D embedding submodule 341 may train the machine learning model to predict a 3D embedding for a given 3D point, where a pair of predicted 3D embeddings are similar to one another (e.g., within a threshold distance in an embedding space from one another) if their corresponding 2D embeddings are similar. Using the MLP ϕ as an example, 3D embeddings ϕ(pᵢ) and ϕ(pⱼ) for the positions pᵢ and pⱼ, respectively, are similar to one another if their corresponding 2D embeddings, xᵢ and xⱼ, are similar.

In some embodiments, the 3D embedding submodule 341 may train the machine learning model to predict 3D embeddings that are similar to one another if both their corresponding 2D embeddings and their corresponding image-space normals are similar. Using the MLP ϕ as an example, the 3D embedding submodule 341 may determine that the 3D embeddings ϕ(pᵢ) and ϕ(pⱼ) are similar if both their corresponding 2D embeddings, xᵢ and xⱼ, are similar and their corresponding image-space normals, nᵢ and nⱼ, are similar.

The 3D embedding submodule 341 may apply an example loss shown in Equation (1), below, to cause the machine learning model to predict 3D embeddings that are similar in response to their corresponding 2D embeddings being similar. This example loss is a push-pull loss that pulls similar data closer together in an embedding space and pushes dissimilar data farther apart in the embedding space.

$${L}_{ϕ} = \{ \begin{matrix}‖ ϕ ( {p}_{i} ) - ϕ ( {p}_{j} ) ‖ , if ‖ {x}_{i} - {x}_{j} ‖ < {t}_{e} and {n}_{i} \cdot {n}_{j} > {t}_{n} \\ max ( 0 , {t}_{p} - ‖ ϕ ( {p}_{i} ) - ϕ ( {p}_{j} ) ‖ ) , otherwise\end{matrix} \qquad ( 1 )$$

Where tₑ is a pull threshold on embeddings, tₙ is a threshold on normals, and tₚ is a push threshold. The 3D embedding submodule 341 may apply sample pairs of 3D points of the same image and apply the loss to the sampled pairs. The 3D embedding submodule 341 may apply backpropagation to optimize the machine learning model (e.g., the MLP ϕ).

The 3D embedding submodule 341 may re-train the machine learning model for predicting 3D embeddings iteratively with subsequent images in a sequence of images of a scene. For example, as new image frames depicting a scene are acquired, the 3D embedding submodule 341 can re-train the machine learning model, updating the weights of the model and re-determining plane instances within the scene. The 3D embedding submodule 341 may train a new machine learning model in response to determining that the client device executing an AR application is in a new scene. For example, the 3D embedding submodule 341 may determine that a user has entered a new room with their client device and in response, prompt the user to capture training images of the new room and train a new MLP for determining a planar representation of the new room.

The 3D embedding submodule 341 or the training module 328 of the game server 320 may train or re-train a machine learning model in advance of real-time plane estimation (e.g., automatically or on-demand). The 3D embedding submodule 341 or the training module 328 may provide the trained model to the client device 310 in advance of real-time plane estimation.

The 3D plane clustering submodule 342 determines a plane instance based on 3D embeddings generated by the 3D embedding submodule 341. A plane instance is a quantitative representation of a 2D surface within a scene. Each determined plane instance may be a distinct 2D surface within the scene. For example, a surface of a coffee table may be represented by a first plane instance, each wall within the scene may be represented by respective plane instances, and a door within one of those walls may be represented by its own plane instance. Two plane instances can be co-planar. In a first example of co-planar surfaces, a door is within a wall, where a first plane instance represents the door and a second plane instance represents the wall. In a second example of co-planar surfaces, a poster is on a wall, where a first plane instance represents the poster and a second plane represents the wall.

The 3D plane clustering submodule 342 may use 3D embeddings corresponding to respective vertices in the 3D mesh (e.g., as generated by the initial scene geometry submodule 340) to cluster the vertices into plane instances. The 3D plane clustering submodule 342 may use geometry information defined by the 3D mesh (e.g., position of vertices, edges connecting the vertices, faces formed by three or more edges, etc.) in addition to the 3D embeddings to determine a plane instance. The 3D plane clustering submodule 342 may use sequential random sample consensus (RANSAC). A subset or all of the vertices in the 3D mesh may form a pool of vertices that the 3D plane clustering submodule 342 can iteratively cycle through to determine plane instances. The 3D plane clustering submodule 342 may perform a sequence of operations iteratively for each vertex in the pool: determine one or more proposed plane instances, randomly sample vertices of the one or more proposed plane instances, determine an inlier count for each proposed plane instance, and select the proposed plane instance having the highest inlier count. The 3D plane clustering submodule 342 determines the selected plane as a plane instance of the scene.

The 3D plane clustering submodule 342 determines a proposed plane instance for the iterated vertex by determining a normal of the vertex and defining the proposed plane using the iterated vertex and the normal. That is, the 3D plane clustering submodule 342 determines the proposed plane instance as one including the iterated vertex and characterized by the determined normal. The 3D plane clustering submodule 342 may determine more than one proposed plane instance for a single, iterated vertex.

When determining a proposed plane instance, the 3D plane clustering submodule 342 may determine that one or more vertices of the pool of vertices belong to the proposed plane instance. The 3D plane clustering submodule 342 may remove vertices associated with the proposed plane instance from the pool. That is, after removing the vertices, the 3D plane clustering submodule 342 may omit performance of the sequence of operations for the removed vertices.

The 3D plane clustering submodule 342 determines an inlier count for a proposed plane instance by identifying, for the vertex being iterated upon, another vertex of the 3D mesh and determines that the other vertex is an inlier to the proposed plane instance based on one or more calculated distances within a 3D embedding space associated with the scene and/or within the 3D mesh. For example, the 3D plane clustering submodule 342 can determine a distance between the potential inlier vertex and the proposed plane instance and compare the determined distance to a threshold distance, R_{d} (e.g., R_{d} is 0.1). If the 3D plane clustering submodule 342 determines that the distance is less than the threshold distance, R_{d}, the 3D plane clustering submodule 342 may determine that the potential inlier vertex is indeed an inlier vertex. Additionally, or alternatively, the 3D plane clustering submodule 342 can determine a distance between a 3D embedding corresponding to the potential inlier vertex and a 3D embedding corresponding to the iterated vertex and compare the determined distance to a threshold distance, Rₑ (e.g., Rₑ is 0.5). If the 3D plane clustering submodule 342 determines that the distance is less than the threshold distance, Rₑ, the 3D plane clustering submodule 342 may determine that the potential inlier vertex is indeed an inlier vertex of the proposed plane instance.

The 3D plane clustering submodule 342 may use clustering means in addition or alternative to RANSAC for clustering vertices of a 3D mesh into plane instances. For example, the 3D plane clustering submodule 342 may use a mean-shift algorithm to cluster vertices into plane instances (e.g., using a mean-shift bandwidth of 0.25). In some embodiments, the 3D plane clustering submodule 342 may switch between using two clustering means depending on the context in which the planes are being identified. For example, the 3D plane clustering submodule 342 may receive a request for a real-time clustering of 3D plane instances and in response, apply a mean-shift algorithm to the vertices of a 3D mesh. In the same example, the 3D plane clustering submodule 342 may receive a request for an asynchronous clustering (e.g., not real-time) and in response, apply a RANSAC algorithm to the vertices of the 3D mesh. In this way, the 3D plane clustering submodule 342 may adapt the clustering means to an appropriate processing context. For example, the 3D plane clustering submodule 342 can apply a less processing intensive mean-shift clustering means when a request demands speed because it is received in real-time as a user is engaging in an AR activity.

After iterating through the pool of vertices and converging upon selected plane instances, the 3D plane clustering submodule 342 merges plane instances that have similar embeddings and normal. In some embodiments, the 3D plane clustering submodule 342 can merge a first and second plane instance where the distance between an average embedding of the first plane instance and an average embedding of the second plane instance is less than a threshold distance (e.g., a threshold distance of 0.2 between the average embeddings) and the dot product between average normals of the respective plane instances is greater than a threshold distance (e.g., a threshold distance of 0.6 between an average normal for the first plane instance and an average normal for the second plane instance).

After merging plane instances, the 3D plane clustering submodule 342 may separate non-contiguous planes by executing a connected components algorithm on the mesh representation of each plane instance. For example, a scene includes two similar desks next to each other with a gap between the desks. The 3D plane clustering submodule 342 may determine two plane instances for the respective desks. However, the two plane instances can fit to both desk surfaces (i.e., a plane instance for one desk may represent the surface of either desk). However, the initial scene geometry submodule 340 may generate a 3D mesh that reflects the two surfaces being disconnected (i.e., vertices representing one desk are not connected by edges to vertices representing the other desk). Thus, the two desks are disconnected in the 3D mesh. The 3D plane clustering submodule 342 may execute a connected components algorithm on the 3D mesh to determine that the surfaces are disconnected. In turn, the 3D plane clustering submodule 342 determines to assign different plane instances to each surface (e.g., one plane instance for each desk surface).

The 3D plane clustering submodule 342 may optionally label each plane instance with unique identifiers for each plane instance. The 3D plane clustering submodule 342 may assign a set of labels to respective 3D plane instances identified via a clustering means and determine whether to assign one of those labels to an unclustered vertex. During the RANSAC operation or any suitable clustering operation that clusters vertices of the 3D mesh into plane instances, the 3D plane clustering submodule 342 may not necessarily cluster all vertices of the 3D mesh. In such circumstances, the 3D plane clustering submodule 342 may identify the unclustered vertices which have not been labeled yet are connected (i.e., an edge in the 3D mesh connects two unclustered vertices). The connected and unclustered vertices may be grouped with one of the labeled plane instances. For example, the 3D plane clustering submodule 342 may determine to assign a connected and unclustered vertex to a labeled plane instance corresponding to the neighboring vertices of the connected and unclustered vertex.

The 3D plane clustering submodule 342 may remove plane instances that are not composed of at least a threshold vertex count (e.g., one hundred vertices). For example, the 3D plane clustering submodule 342 determines to ignore or exclude from further processing a plane instance composed of ninety vertices.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, a training module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The training module 328 trains the one or more models of the 3D plane module 319 (e.g., the MLP of the 3D embedding estimation submodule) for use by client devices 310. As described previously, the MLP of the 3D embedding estimation submodule receives the 3D mesh as input from the initial scene geometry submodule and distill the per-pixel embeddings into 3D-consistent embeddings without needing to be trained on the specific scene itself. Although the training module 328 is shown as part of the game server 320 for convenience, the training module 328 may be trained and provided to client devices 310 by another system or systems. For example, the MLP may be trained by a development system and incorporated in an application that is downloaded to client devices 310 from an app store.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

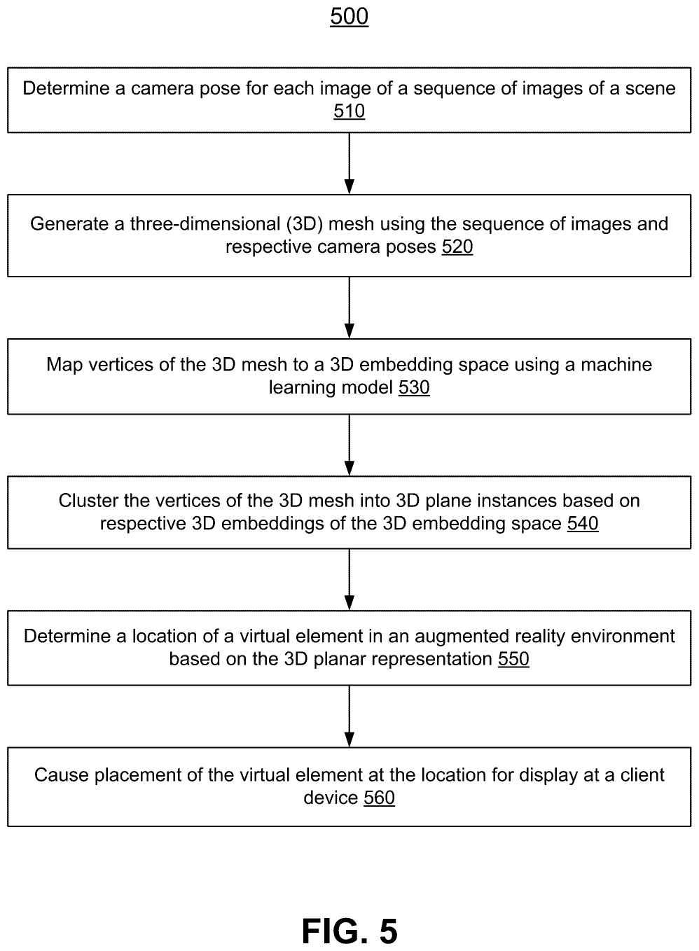

FIG. 4 depicts a block diagram of a process 400 for determining planar representations of a scene, in accordance with at least one embodiment. The process 400 is described as performed by the 3D plane module 319 of the client device 310; however, the process 400 may be performed by components of the game server 320, or a combination of the 3D plane module 319 and the game server 320. Another example of determining a planar representation of a scene is described with respect to FIG. 5.

For a given pixel of an image of the images 410 of a scene, the 3D plane module 319 may determine a 2D embedding 420, an image-space normal 421, a per-pixel depth 422, and a planar probability 423. The 2D embeddings 420 and the normals 421 may be used to supervise 424 the training of a MLP 440. The depths 422 and planar probabilities 423 may be fused into a TSDF 430, the output of which is a 3D mesh that is visually represented in FIG. 4 by 3D coordinates, (x, y, z). The 3D plane module 319 uses the MLP 440 to predict 3D embeddings based on the 3D mesh. The MLP 440 may be trained for a particular scene, and the 3D plane module 319 may use a different MLP for determining plane instances of a different scene. The 3D plane module 319 applies a cluster mechanism 450 (e.g., a RANSAC algorithm or a mean-shift algorithm) to the 3D embeddings output by the MLP 440. The 3D plane module 319 identifies plane instances 460 within the scene based on clustered 3D embeddings. A first plane instance 461 is a wall in the scene and a second plane instance 462 is a painting in the scene.

### Example Methods

FIG. 5 is a flowchart describing an example method 500 for causing placement of a virtual object at a determined planar representation of a scene, according to one or more embodiments. The method 500 is described as performed by the client device 310 (e.g., the 3D plane module 319 performs one or more operations of the method 500). However, some or all of the steps may be performed by other entities or components (e.g., components of the game server 320). In addition, some embodiments may perform the steps in parallel, perform the steps in different orders, or perform different steps.

The localization module 318 determines 510 a camera pose for each image of a sequence of images of a scene. A camera pose may be characterized by the location and orientation of the camera within the environment. The camera pose may be determined based on sensor data associated with each image (e.g., using a wireless local area network sensor to establish the location of the camera within the environment). In one example, the localization module 318 may determine that thirty five images of scene are taken from the center of a room at approximately ten degree angles from one another. The room may include four walls, where one wall includes a door. Each wall and the door are distinct surfaces.

The 3D plane module 319 generates 520 a 3D mesh using the sequence of images and respective camera poses. The initial scene geometry submodule 340 can, for one or more images of the sequence of images, determine for a given pixel of a given image, the pixel depth and probability that the pixel belongs to a planar region of the room. Following the prior example, the 3D plane module 319 may generate 520 a 3D mesh of the room. The initial scene geometry submodule 340 can determine, for a pixel depicting part of the door of the room, a particular depth value, a high probability that the pixel belongs to a planar region of the room, and a 2D embedding. The initial scene geometry submodule 340 may perform this determination for pixels of one or more images of the room.

The 3D plane module 319 maps 530 vertices of the 3D mesh to a 3D embedding space using a machine learning model. The 3D embedding submodule 341 may apply an MLP that receives as input the vertices of the 3D mesh and outputs, for each vertex, a predicted 3D embedding mapped in the 3D embedding space. The 3D embedding is a multi-view consistent embedding. Following the previous example, the 3D embedding submodule 341 determines a 3D embedding for a pixel depicting a portion of the door in a first image and the same 3D embedding for a pixel depicting the same portion of the door in a second image. The 3D embedding is the same across both the first and second image despite the different camera pose associated with the images.

The 3D plane module 319 clusters 540 the vertices of the 3D mesh into 3D plane instances based on respective 3D embeddings of the 3D embedding space. The 3D plane clustering submodule 342 may use RANSAC to cluster the vertices. The 3D plane clustering submodule 342 uses the 3D embeddings determined by the 3D embedding submodule 341 when applying RANSAC. When determining whether a vertex is an inlier in a proposed plane instance, the 3D plane clustering submodule 342 can determine whether the Euclidean distance between 3D embeddings of two vertices is less than a threshold distance. Following the previous example, the 3D plane clustering submodule 342 may apply RANSAC to vertices of a 3D mesh representing the room. The 3D plane clustering submodule 342 may iterate through a pool of the vertices and determine a plane instance representing the door in the room in response to at least determining that two vertices and their corresponding 3D embeddings are within a threshold Euclidean distance of one another, where the two vertices correspond to pixels depicting the door. The 3D plane clustering submodule 342 may assign a label to the determined plane instance. The 3D plane clustering submodule 342 may similarly determine plane instances for each of the four walls of the room.

The gaming module 314 determines 550 a location of a virtual element in an AR environment based on the 3D planar representation. Following the previous example, the gaming module 314 may determine 550 the door as the location to place a virtual poster based on the plane instances representing the door and its surrounding wall. The gaming module 314 may determine that the virtual poster cannot be placed in an area including both the plane instance for the door and the wall (e.g., the poster cannot be placed partly across the door and partly across the wall because the poster is not intended to be folded each time the door opens). The gaming module 314 may receive a request to place a virtual element (e.g., an AR object) on an area of the scene that extends across at least two plane instances. The gaming module 314 can identify a type of AR object and in response to determining that the type of AR object cannot be placed at the requested area, recommend a second area that does not extend beyond one of the at least two plane instances. In the previous example, the gaming module 314 may recommend that the user place the virtual poster on either the door or the wall, but not an area that extends across both.

The gaming module 314 causes 560 placement of the virtual element at the location for display at a client device. Following the previous example, the gaming module 314 causes the virtual poster to be displayed at the door of the room for display at a smartphone on which a user is running an AR interior design simulation game.

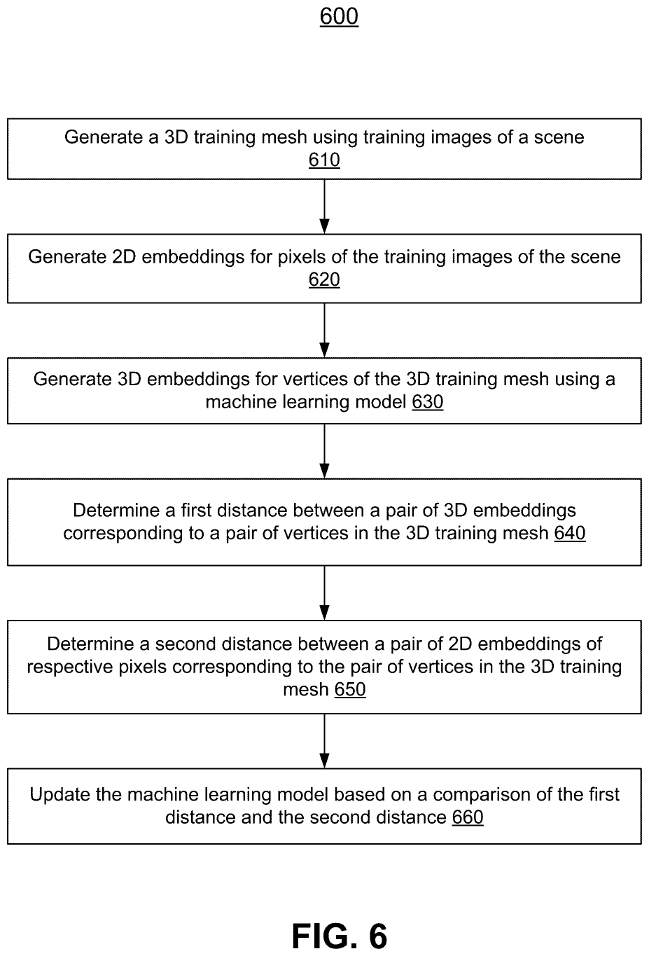

FIG. 6 is a flowchart describing an example method 600 for training a machine learning model to determine multi-view consistent embeddings of a scene, according to one or more embodiments. The method 600 may be one iteration among multiple iterations for training a machine learning model that are performed until an end condition is met. For example, the method 600 may be performed until a predefined number of iterations are taken. In another example, the method 600 may be performed until an error metric is less than a threshold. The method 600 is described as performed by the client device 310 (e.g., the 3D plane module 319 performs the method 500). However, some or all of the steps may be performed by other entities or components (e.g., components of the game server 320). In addition, some embodiments may perform the steps in parallel, perform the steps in different orders, or perform different steps.

The 3D plane module 319 generates 610 a 3D training mesh using training images of a scene. For one or more training images, the 3D plane module 319 may determine pixel depth, planar probability, a 2D planar embedding, and image-space normals of at least a pair of pixels in a given training image. The 3D plane module 319 may determine the plane probabilities, 2D planar embeddings, and image-space normal of all pixels in a given training image. The 3D plane module 319 may determine a 3D mesh of the scene by fusing the pixel depths and planar probabilities into a TSDF. In one example, the 3D plane module 319 generates 610 a 3D training mesh using pictures of a room having four walls, a table, and two chairs using training images taken of the room at different camera poses.

The 3D plane module 319 generates 620 2D embeddings for pixels of the training images of the scene. Following the previous example, the 3D plane module 319 generates 620 2D embeddings for training image pixels using a neural network. The neural network may be trained to identify pixels depicting the same plane in a given training image, outputting the same or similar quantitative value for pixels that depict same plane in a single image. However, the neural network may be unable to identify the same plane across different images, outputting different quantitative values for a pixel depicting a plane in a first training image and a pixel depicting the same plane in a second training image. The neural network trained to generate 2D embeddings may be trained such that a first distance between two 2D embeddings associated with a plane in a first image may be similar or the same as a second distance between two 2D embeddings in a second image depicting the same plane despite each of the four 2D embeddings having different quantitative values representing a planar surface.

The quantitative values associated with 2D embeddings may nevertheless be used by the 3D plane module 319 as supervisory signals for optimizing a machine learning model to predict 3D embeddings that are multi-view consistent embeddings. That is, the 3D plane module 319 may train the machine learning model to generate 3D embeddings that are closer in a 3D embedding space if corresponding 2D embeddings of pixels in a single image have similar quantitative values indicating that the pixels belong to the same plane.

The 3D plane module 319 generates 630 3D embeddings for vertices of the 3D training mesh using a machine learning model. The 3D plane module 319 may initialize weights of the machine learning model to generate 3D embeddings for corresponding vertices of the 3D training mesh. The 3D plane module 319 may determine the accuracy of the predicted 3D embeddings by comparing a pair of 3D embeddings to a corresponding pair of 2D embeddings.

The 3D plane module 319 determines 640 first distance between a pair of 3D embeddings corresponding to a pair of vertices in the 3D training mesh. The 3D plane module 319 may determine 640 a Euclidean distance that is less than a threshold distance, indicative that the pair are associated with a single plane instance. The pair of vertices may correspond to a pair of pixels in a training image of the scene.

The 3D plane module 319 determines 650 a second distance between a pair of 2D embeddings of respective pixels corresponding to the pair of vertices in the 3D training mesh. The second distance may represent whether the pixels belong to the same plane instance (e.g., two pixels depicting the same table surface in a room). That is, the second distance between two 2D embeddings being at or below a threshold distance may indicate that two corresponding pixels depict the same plane in a scene and the second distance exceeding the threshold distance may indicate that the two corresponding pixels do not belong to the same plane.

The 3D plane module 319 updates 660 the machine learning model based on a comparison of the first distance and the second distance. If the second distance is small, that indicates that the corresponding pair of pixels are likely to be in the same plane, so the first distance should also be small (indicating the pair of vertices corresponding to the pair of pixels are in the same plane). Conversely, if the second distance is large, indicating the pair of pixels are unlikely to be in the same plane, the first distance should also be large. The 3D plane module 319 may update 660 the machine learning model by updating its weights such that the first distance has better agreement with the second distance in future iterations (i.e., the 3D embeddings are similar for vertices for which the corresponding pixels have similar 2D embeddings and vice versa).

The method 600 may include operations that are iterated upon during a training process for the machine learning model. For example, the generation 630 of 3D embeddings, determinations 640 and 650, and the updating 660 may be iterated upon until an end condition is reached. Example end conditions include a predefined number of training iterations being met or an error metric not exceeding a threshold. The 3D plane module 319 may determine, using the first distance or second distance, an error metric of the machine learning model (e.g., using the loss as calculated using Eqn. (1)). Until an end condition has been met, the 3D plane module 319 may return to generating 630 3D embeddings after updating the machine learning model, recomputing plane assignments based on the subsequently generated 3D embeddings. Once an end condition has been met, the 3D plane module 319 may finish training the machine learning model, and the model may be ready to support online inference.

### Example Computing System

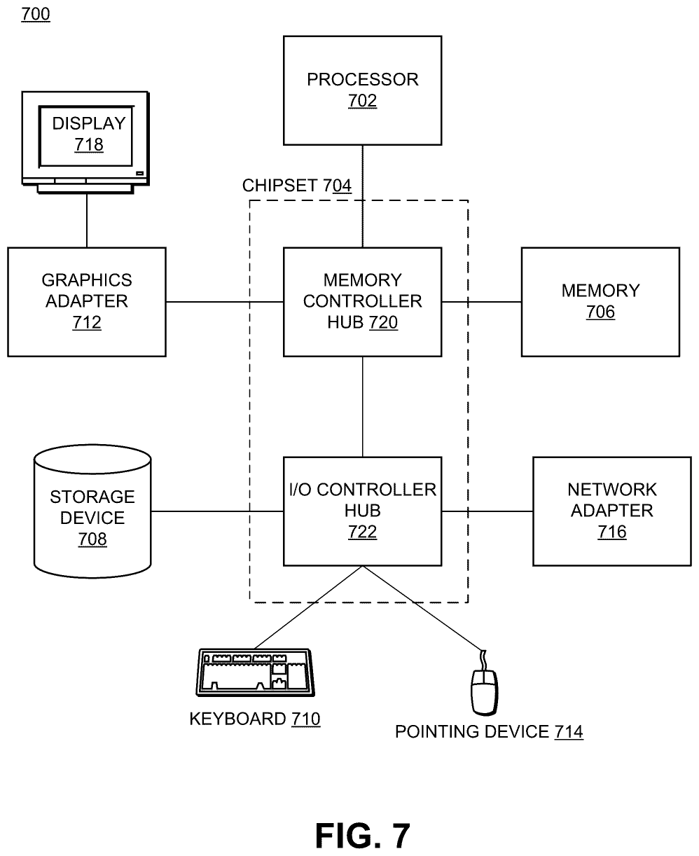

FIG. 7 is a block diagram of an example computer 700 suitable for use as a client device 310 or game server 320. The example computer 700 includes at least one processor 702 coupled to a chipset 704. References to a processor (or any other component of the computer 700) should be understood to refer to any one such component or combination of such components working cooperatively to provide the described functionality. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, keyboard 710, pointing device 714, and network adapter 716 are coupled to the I/O controller hub 722. Other embodiments of the computer 700 have different architectures.

In the embodiment shown in FIG. 7, the storage device 708 is a non-transitory computer-readable storage medium such as a hard drive, compact disk read-only memory (CD-ROM), DVD, or a solid-state memory device. The memory 706 holds instructions and data used by the processor 702. The pointing device 714 is a mouse, track ball, touch-screen, or other type of pointing device, and may be used in combination with the keyboard 710 (which may be an on-screen keyboard) to input data into the computer system 700. The graphics adapter 712 displays images and other information on the display 718. The network adapter 716 couples the computer system 700 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 710, graphics adapters 712, and displays 718.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
determining a camera pose for each image of a sequence of images of a scene, the scene comprising planar surfaces in the scene;
generating a three-dimensional (3D) mesh using the sequence of images and respective camera poses, the 3D mesh comprising vertices corresponding to respective locations in the scene;
mapping vertices of the 3D mesh to a 3D embedding space using a machine learning model, wherein a given pair of vertices on the same planar surface in the scene correspond to a pair of 3D embeddings of the 3D embedding space, the distance between the pair of 3D embeddings not exceeding a threshold distance;
clustering the vertices of the 3D mesh into 3D plane instances based on respective 3D embeddings of the 3D embedding space, wherein the 3D plane instances correspond to the respective planar surfaces in the scene;
determining a location of a virtual element in an augmented reality (AR) environment based on the 3D plane instances; and
causing placement of the virtual element at the location for display at a client device.

2. The computer-implemented method of claim 1, wherein the vertices are a first subset of vertices of the 3D mesh and wherein a second subset of vertices of the 3D mesh are not clustered, further comprising:
assigning a set of labels to respective the 3D plane instances; and
grouping the second subset of vertices with respective labeled 3D plane instances.

3. The computer-implemented method of claim 1, further comprising:
identifying a plane instance of the 3D plane instances comprising fewer than a threshold vertex count; and
removing the identified plane instance from the 3D plane instances.

4. The computer-implemented method of claim 1, further comprising training the machine learning model using 2D embeddings generated based on training images of the scene by:
generating a 3D training mesh using the training images of the scene;
generating 2D embeddings for pixels of the training images of the scene;
generating 3D embeddings for vertices of the 3D training mesh using the machine learning model;
determining a first distance between a pair of 3D embeddings corresponding to a pair of vertices in the 3D training mesh, the pair of vertices corresponding to a pair of pixels in a training image of the scene;
determining a second distance between a pair of 2D embeddings of respective pixels corresponding to the pair of vertices in the 3D training mesh;
and
updating the machine learning model based on a comparison of the first distance and the second distance.

5. The computer-implemented method of claim 1, wherein clustering the vertices of the 3D mesh into 3D plane instances comprises:
in response to receiving a request for a real-time clustering of 3D plane instances, applying a mean-shift algorithm to the vertices of the 3D mesh; and
in response to receiving a request for an asynchronous clustering of 3D plane instances, applying a random sample consensus (RANSAC) algorithm to the vertices of the 3D mesh by:
randomly sampling proposed 3D plane instances,
determining an inlier count for each proposed 3D plane instance sampled, and
selecting a proposed 3D plane instance having a threshold number of inlier vertices.

6. The computer-implemented method of claim 1, further comprising:
receiving a request to place an AR object on a first area of the 3D scene;
determining that the first area extends across at least two of the plane instances;
identifying a type of AR object; and
in response to determining that the type of AR object cannot be placed on the area, recommending a second area that does not extend beyond one of the at least two plane instances.

7. The computer-implemented method of claim 1, wherein the scene is a first room and wherein the machine learning model is a first multilayer perceptron (MLP), further comprising:
in response to determining that a user has entered a second room:
prompting the user to capture images of the second room; and
training a second MLP the second room.

8. The computer-implemented method of claim 1, wherein the augmented reality environment is a parallel reality game.

9. The computer-implemented method of claim 1, wherein the sequence of images of a scene comprises images of a room taken at two or more angles about a fixed spot in the room.

10. The computer-implemented method of claim 1, wherein generating the 3D mesh using the sequence of images and the respective camera poses comprises:
estimating depth maps based on the sequence of images and the respective camera poses;
fusing the depth maps into a truncated signed distance function (TSDF); and
extracting the 3D mesh based on the TSDF.

11. A non-transitory computer-readable medium comprising instructions, the instructions, when executed by a computer system, causing the computer system to perform operations including:
determining a camera pose for each image of a sequence of images of a scene, the scene comprising planar surfaces in the scene;
generating a 3D mesh using the sequence of images and respective camera poses, the 3D mesh comprising vertices corresponding to respective locations in the scene;
mapping vertices of the 3D mesh to a 3D embedding space using a machine learning model, wherein a given pair of vertices on the same planar surface in the scene correspond to a pair of 3D embeddings of the 3D embedding space, the distance between the pair of 3D embeddings not exceeding a threshold distance;
clustering the vertices of the 3D mesh into 3D plane instances based on respective 3D embeddings of the 3D embedding space, wherein the 3D plane instances correspond to the respective planar surfaces in the scene;
determining a location of a virtual element in an AR environment based on the 3D plane instances; and
causing placement of the virtual element at the location for display at a client device.

12. The non-transitory computer-readable medium of claim 11, wherein the vertices are a first subset of vertices of the 3D mesh and wherein a second subset of vertices of the 3D mesh are not clustered, and wherein the operations further comprise:
assigning a set of labels to respective the 3D plane instances; and
grouping the second subset of vertices with respective labeled 3D plane instances.

13. The non-transitory computer-readable medium of claim 11, wherein the operations further comprise:
identifying a plane instance of the 3D plane instances comprising fewer than a threshold vertex count; and
removing the identified plane instance from the 3D plane instances.

14. The non-transitory computer-readable medium of claim 11, wherein the operations further comprise training the machine learning model using 2D embeddings generated based on training images of the scene by:
generating a 3D training mesh using the training images of the scene;
generating 2D embeddings for pixels of the training images of the scene;
generating 3D embeddings for vertices of the 3D training mesh using the machine learning model;
determining a first distance between a pair of 3D embeddings corresponding to a pair of vertices in the 3D training mesh, the pair of vertices corresponding to a pair of pixels in a training image of the scene;
determining a second distance between a pair of 2D embeddings of respective pixels corresponding to the pair of vertices in the 3D training mesh;
and
updating the machine learning model based on a comparison of the first distance and the second distance.

15. The non-transitory computer-readable medium of claim 11, wherein clustering the vertices of the 3D mesh into 3D plane instances comprises:
in response to receiving a request for a real-time clustering of 3D plane instances, applying a mean-shift algorithm to the vertices of the 3D mesh; and
in response to receiving a request for an asynchronous clustering of 3D plane instances, applying a RANSAC algorithm to the vertices of the 3D mesh by:
randomly sampling proposed 3D plane instances,
determining an inlier count for each proposed 3D plane instance sampled, and
selecting a proposed 3D plane instance having a threshold number of inlier vertices.

16. The non-transitory computer-readable medium of claim 11, wherein the operations further comprise:
receiving a request to place an AR object on a first area of the 3D scene;
determining that the first area extends across at least two of the plane instances;
identifying a type of AR object; and
in response to determining that the type of AR object cannot be placed on the area, recommending a second area that does not extend beyond one of the at least two plane instances.

17. The non-transitory computer-readable medium of claim 11, wherein the scene is a first room and wherein the machine learning model is a first MLP, wherein the operations further comprise:
in response to determining that a user has entered a second room:
prompting the user to capture images of the second room; and
training a second MLP the second room.

18. The non-transitory computer-readable medium of claim 11, wherein the augmented reality environment is a parallel reality game.

19. The non-transitory computer-readable medium of claim 11, wherein the sequence of images of a scene comprises images of a room taken at two or more angles about a fixed spot in the room.

20. The non-transitory computer-readable medium of claim 11, wherein generating the 3D mesh using the sequence of images and the respective camera poses comprises:
estimating depth maps based on the sequence of images and the respective camera poses;
fusing the depth maps into a truncated signed distance function (TSDF); and
extracting the 3D mesh based on the TSDF.
